(19) United States
(12) Patent Application Publication
(10) Pub. No.: US 2023/0075163 A1
(43) Pub. Date: Mar. 9, 2023

(54) BIO-BASED RESINS, COMPOSITIONS, AND METHODS THEREOF

(71) Applicant: INGEVITY SOUTH CAROLINA, LLC, North Charleston, SC (US)

(72) Inventors: Yongning Liu, Apex, NC (US); Wumin Yu, Mount Pleasant, SC (US); Zhigang Chen, Mount Pleasant, SC (US)

(21) Appl. No.: 17/822,151

(22) Filed: Aug. 25, 2022

Related U.S. Application Data
(60) Provisional application No. 63/239,584, filed on Sep. 1, 2021.

(51) Int. Cl. C08G 18/36; C08G 59/32; C08G 59/42; C08G 18/42; C08G 18/58; C08G 18/34; C08G 18/66

(52) U.S. Cl. CPC C08G 18/36; C08G 59/32; C08G 59/4292; C08G 18/4277; C08G 18/58; C08G 18/34; C08G 18/6629; C08G 18/6603; C08G 18/6637

(57) ABSTRACT

A bio-based resin obtained from a reaction mixture comprising a glycidyl ether component and a bio-based component comprising a fatty acid and a rosin acid, wherein the glycidyl ether component comprises at least two epoxide groups.

### CROSS-REFERENCE TO RELATED APPLICATIONS

This application claims the benefit of and priority to U.S. Provisional Application No. 63/239,584, filed 1 Sep. 2021, which is incorporated by reference herein in its entirety for all purposes.

### BACKGROUND OF THE INVENTION

Field of the Discovery. The present disclosure relates to bio-based resins, compositions including bio-based resins, polyurethanes derived from bio-based resins, curable compositions, and methods for preparing bio-based resins.

Background Information. This disclosure relates to epoxy resins, and in particular to bio-based resins, compositions, methods of manufacture, and uses thereof.

Epoxy resins are useful in the manufacture of articles and components for a wide range of applications, such as adhesives, coatings, laminates, castings, encapsulations and moldings. However, most conventional epoxy resins are derived from petroleum sources. With the increasing awareness of future depletion of fossil fuel reserves, as well as the desire to move toward more environmentally friendly and sustainable “green” feedstocks, use of bio-based feedstocks to develop bio-based resins has attracted increasing attention.

Bio-based feedstocks include fatty acids derived from plant-based oils including but not limited to soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, and combinations thereof. Other bio-based feedstocks include rosin acids including gum rosin acid, wood rosin acid, tall oil rosin acid, or a combination thereof.

Distilled tall oil (DTO) is a 100% bio-based refinery product from the by-product in pine wood pulping. DTO includes tall oil fatty acids (oleic, linoleic, palmitic, palmitoleic, stearic and others) and rosin acids (abietic, dehydroabietic, palustric, neoabietic, isopimaric and others). Attempts have been made to incorporate fatty acids or rosin acids into epoxy resins. For example, U.S. Pat. No. 6,673,877 discloses binders for aqueous corrosion protection systems from the reaction epoxide compounds, fatty acids, amines. WO 2019101916 discloses curable composition based on fatty-acid modified epoxy resins. U.S. Pat. No. 4,786,666 discloses high-solids coating compositions by reacting bisphenol A diglycidyl ether, bisphenol A and tall oil fatty acids. U.S. Pat. No. 4,116,901 discloses a low temperature curing epoxy ester by reacting bisphenol A diglycidyl ether, castor oil fatty acids, and tall oil fatty acids. U.S. Pat. No. 8,709,694 B2 discloses a rosin diol obtained from reaction of bisphenol A-epichlorohydrin monomer with rosin, which can be used as one of the components in polyurethane synthesis. U.S. Pat. No. 4,088,618 discloses rosin-modified epoxy resins obtained from reacting a bisphenol A epichlorohydrin resin with tall oil rosin.

Previous attempts have been made to incorporate fatty acids into epoxies. Using fatty acids to modify an epoxy resin may reduce mechanical strength and thermal stability. Using only rosin acid to modify an epoxy resin may lead to a brittle solid or highly viscous liquid. There accordingly remains a need in the art for bio-based resins that provide improved mechanical strength and thermal stability while, maintaining good toughness and flexibility.

### SUMMARY

Presently described are bio-based resins, curable compositions including bio-based resins, polyurethanes derived from bio-based resins, and methods of their preparation and use.

Thus, in an aspect, the disclosure provides a bio-based resin obtained from a reaction mixture comprising a glycidyl ether component and a bio-based component comprising a fatty acid and a rosin acid, wherein the glycidyl ether component comprises at least two epoxide groups.

In other aspects, the disclosure provides methods of making and methods of using bio-based resins described herein.

In further aspects, the disclosure provides a polyurethane derived from the bio-based resins described herein.

The preceding general areas of utility are given by way of example only and are not intended to be limiting on the scope of the present disclosure and appended claims. Additional objects and advantages associated with the compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### BRIEF DESCRIPTION OF THE DRAWINGS

FIG. 1 shows the glass transition temperatures (Tg) of compositions including combinations of bio-based resin synthesized in Synthesis Example 8 (GA500) or Synthesis Example 9 (GA550) with either castor oil or a polycaprolactone polyol.

FIG. 2 show the elongation at break for polyurethane films derived from bio-based resins in combination with one or both of polycaprolactone polyols, and polyols derived from castor oil.

FIG. 3 show the water absorption behavior for polyurethane films derived from bio-based resins in combination with one or both of polycaprolactone polyols, and polyols derived from castor oil.

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of’ or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of’ and “consisting essentially of’ shall be closed or semi-closed transitional phrases, respectively, as set forth in the 10 United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. It should also be understood that, unless clearly indicated to the contrary, in any methods claimed herein that include more than one step or act, the order of the steps or acts of the method is not necessarily limited to the order in which the steps or acts of the method are recited.

### Exemplary Aspects and Embodiments

Surprisingly and unexpectedly, the inventors of the present disclosure found that the reaction product obtained from the reaction of a glycidyl ether component and a bio-based component comprising a fatty acid and a rosin acid, wherein the glycidyl ether component comprises at least two epoxide groups has a balance of properties including mechanical strength, thermal stability, toughness, and flexibility. The disclosed compositions and methods relate to bio-based resin, a polyurethane derived from the bio-based resin, curable compositions including the bio-based resin; methods for preparing the bio-based resin; and methods for preparing curable compositions including the bio-based resin.

As described above, conventional epoxy resins and epoxy resin compositions are derived from petroleum sources. It would be an advantage to incorporate bio-based feedstocks such as bio-based fatty acids and bio-based rosin acids into epoxy resins to provide more environmentally-friendly epoxy resins. It would be a further advantage if the desirable properties associated with epoxy resins were maintained or improved.

In any of the aspects or embodiments described herein, a bio-based resin obtained from a reaction mixture comprises a glycidyl ether component and a bio-based component comprising a fatty acid and a rosin acid, wherein the glycidyl ether component comprises at least two epoxide groups. In any aspect or embodiment described herein, the bio-based resin is a functionalized oligomer resin (for example, the bio-based resin is not a polymer).

In any aspect or embodiment described herein, the bio-based component includes fatty acids and rosin acids. In any aspect or embodiment described herein, the fatty acid is derived from at least one soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, or a combination thereof. In any aspect or embodiment described herein, the rosin acid includes at least one gum rosin acid, wood rosin acid, tall oil rosin acid, or a combination thereof.

In any aspect or embodiment described herein, the bio-based resins of the present disclosure have an acid number less than or equal to about 5, less than or equal to about 4, less than or equal to about 3, less than or equal to about 2, or less than or equal to about 1 mg KOH/g, as determined according to ASTM D664. In any aspect or embodiment described herein, the bio-based resins of the present disclosure have an epoxide equivalent weight of about 200 to about 800 g/eq, about 400 to about 800 g/eq, or a combination thereof. In any aspect or embodiment described herein, the bio-based resins of the present disclosure have an epoxide equivalent weight of greater than about 10,000 g/eq, greater than about 5,000 g/eq, or a combination thereof.

In any aspect or embodiment described herein, the bio-based component distilled tall oil (DTO). DTO is a mixture of rosin acids and tall oil fatty acids (TOFA). DTO rosin acids include C₂₀ mono-carboxylic acids with a core having a fused carbocyclic ring system comprising double bonds that vary in number and location. Examples of rosin acids include abietic acid, neoabietic acid, pimaric acid, levopimaric acid, sandaracopimaric acid, isopimaric acid, and palustric acid. TOFAs can have a range of chain lengths. In any aspect or embodiment described herein, the TOFAs range from C-16 to C-29. In any aspect or embodiment described herein, DTO further contain dimerized rosin acids and dehydroabietic acids formed during the Kraft process and distillation of crude tall oil (CTO). In any aspect or embodiment described herein, DTO includes fatty acid derivatives and/or rosin acid derivatives. In any aspect or embodiment described herein rosin acid derivatives include hydrogenated rosins, disproportionated rosins, maleic anhydride modified rosins, fumaric acid modified rosins, and the like, or a combination thereof. In any aspect or embodiment describe herein, fatty acid derivatives include dimer fatty acids (e.g., DTC-1500 from INGEVITY), acid-modified fatty acids, such as acrylic acid modified fatty acids (e.g., DIACID 1550 from INGEVITY), maleic anhydride modified fatty acids (e.g., TENAX 2010 from INGEVITY), or a combination thereof.

In any aspect or embodiment described herein, bio-based components, which include fatty acids and rosin acids, have a variable rosin acid content. In any aspect or embodiment described herein, the bio-based components include about 1 to about 99 wt %, (e.g., about 30 to about 80 wt %) fatty acids and about 1 to about 99 wt % (e.g., about 20 to about 70 wt %) rosin acids. For example, in any aspect or embodiment described herein, the bio-based components present in the reaction mixture to obtain bio-based resin can have from about 1 wt % to about 99 wt %, about 5 wt % to about 95 wt %, about 10 wt % to about 90 wt %, about 15 wt % to about 80 wt %, about 20 wt % to about 70 wt %, about 20 wt % to about 50 wt %, about 20 wt % to about 30 wt %, about 20 wt % to about 28 wt %, 28 wt % to about 70 wt %, or about 28 wt % to about 50 wt %, each based on the total weight of bio-based component. In any aspect or embodiment described herein, the bio-based component can be a distilled tall oil. Commercially available DTOs with variable rosin acid content include ALTAPYNE 226 (20 wt % rosin acid), ALTAPYNE 28B (28 wt % rosin acid), ALTAPYNE M50 (50 wt % rosin acid), and ALTAPYNE M70 (70 wt % rosin acid), all from INGEVITY. In any aspect or embodiment described herein, the distilled talk oil includes about 20 to about 70 wt % rosin acid (e.g., 20 wt % to about 50 wt %, about 20 to about 28 wt %, about 28 to about 70 wt %, about 28 to about 50 wt %, about 50 wt % to about 70 wt % rosin acid).

A glycidyl ether component is present in the reaction mixture for obtaining a bio-based resin. In any aspect or embodiment described herein, the glycidyl ether component includes glycidyl ether resin, a glycidyl ether compound, or a combination thereof. As used herein, a “glycidyl ether resin” is an oligomer or a polymer including a glycidyl ether compound and a “glycidyl ether compound” is a monomer. Examples of glycidyl ether compounds include bisphenol A diglycidyl ether. The glycidyl ether component comprises at least two epoxide groups. As such, in any aspect or embodiment described herein, the glycidyl ether component is a diglycidyl ether, a triglycidyl ether, a tetraglycidyl ether, and the like, or a combination thereof.

In any aspect or embodiment described herein, the glycidyl ether component includes a bisphenol epoxy resin, a novolac epoxy resin, a diglycidyl ether, triglycidyl ether, tetraglycidyl ether, or a combination thereof. In any aspect or embodiment described herein, the bisphenol epoxy resin is obtained from the reaction of a bisphenol with epichlorohydrin. In any aspect or embodiment described herein, the bisphenol epoxy resin includes bisphenol A epoxy resin, bisphenol F epoxy resin, or a combination thereof. In any aspect or embodiment described herein, the bisphenol epoxy resin is a liquid epoxy resin and has an epoxide equivalent weight of about 150 to about 200, or about 160 to about 200, or about 170 to about 200, or about 180 to about 200 grams per equivalent, as determined according to ASTM D1652. In any aspect or embodiment described herein, the bisphenol epoxy resin is or includes bisphenol A epoxy resin, which is commercially available as EPON 828; from Hexion, having an epoxide equivalent weight of about 185 to about 192 grams per equivalent.

In any aspect or embodiment described herein, the novolac epoxy resin is the reaction product of a phenolic compound (such as phenol, o-, m-, or p-cresol, or a combination thereof) with an aldehyde (such as formaldehyde, benzaldehyde, acetaldehyde, and the like, or a combination thereof). For example, in any aspect or embodiment described herein, the novolac epoxy resin is or includes a phenol-formaldehyde copolymer, wherein the phenolic ring is substituted with a glycidyl ether group. In any aspect or embodiment described herein, the novolac epoxy has an average epoxy functionality of about 2 to about 6, about 3 to about 6, about 3 to about 5, or about 3 to about 4. In any aspect or embodiment described herein, the novolac epoxy has an epoxide equivalent weight as measured by ASTM D 1652 of about 150 to about 200, about 160 to about 190, about 170 to about 190, or about 170 to about 185 grams per equivalent. In any aspect or embodiment described herein, the novolac epoxy resin is or includes D.E.N. 438, from Olin, having an epoxide equivalent weight of about 176 to about 181 grams per equivalent.

In any aspect or embodiment described herein, the glycidyl ether component includes a glycidyl ether compound such as a diglycidyl ether, triglycidyl ether, tetraglycidyl ether, or a combination thereof. In any aspect or embodiment described herein, the diglycidyl ethers includes a diglycidyl ether of neopentyl glycol, a diglycidyl ether of 1,4-butanediol, a diglycidyl ether of resorcinol, or a combination thereof. In any aspect or embodiment described herein, the triglycidyl ether includes trimethylolpropane triglycidyl ether. In any aspect or embodiment described herein, the tetraglycidyl ether includes pentaerythritol tetraglycidyl ether.

In any aspect or embodiment described herein, the bio-based resin includes bisphenol A epoxy resin as the glycidyl ether component, and the bio-based component is a distilled tall oil comprising up to about 50 wt %, about 20 wt % to about 50 wt %, about 20 wt % to about 30 wt %, about 20 wt % to about 28 wt %, or about 28 wt % to about 50 wt % rosin acids, each based on the total weight of the distilled tall oil. In any aspect or embodiment described herein, when the glycidyl ether component includes novolac epoxy resin, lower rosin acid content bio-based components are preferred due to the increase in viscosity that results with higher rosin content.

In any aspect or embodiment described herein, the bio-based resin includes a mixture of bisphenol A epoxy resin and novolac epoxy resin as the glycidyl ether component, and the bio-based component is a distilled tall oil comprising up to about 50 wt %, about 20 wt % to about 50 wt %, about 20 wt % to about 30 wt %, about 20 wt % to about 28 wt %, or about 28 wt % to about 50 wt % rosin acids, based on the total weight of the distilled tall oil. Rosin content higher than about 50 wt % may result in a highly viscous mixture that is not practically useful.

In any aspect or embodiment described herein, the bio-based resin includes a mixture of a triglycidyl ether and novolac epoxy resin as the glycidyl ether component, and the bio-based component is a distilled tall oil comprising up to about 50 wt %, about 20 wt % to about 50 wt %, about 20 wt % to about 30 wt %, about 20 wt % to about 28 wt %, or about 28 wt % to about 50 wt % rosin acids, based on the total weight of the distilled tall oil.

In any aspect or embodiment described herein, the glycidyl ether component is trimethylolpropane triglycidyl ether, wherein the bio-based component is a distilled tall oil comprising about 50 wt % to about 70 wt % rosin acids, based on the total weight of the distilled tall oil.

In any aspect or embodiment described herein, the bio-based resin can have a bio-content. In any aspect or embodiment described herein, the bio-content is the wt % of the total of the bio-based component. In any aspect or embodiment described herein, the bio-content is from about 20 to about 60 wt %, about 25 to about 60 wt %, about 30 wt % to about 60 wt %, about 40 wt % to about 60 wt %, about 50 wt % to about 60 wt %, about 20 wt % to about 50 wt %, about 25 wt % to about 50 wt %, about 30 wt % to about 50 wt %, or about 40 wt % to about 50 wt %, based on the total weight of the bio-based resin.

Methods for preparing a bio-based resin include the steps of
a. admixing a glycidyl ether component and a bio-based component to form a reaction mixture;
b. heating the reaction mixture;
c. adding a catalyst to the reaction mixture; and
d. allowing the reaction to proceed until the reaction mixture has an acid number of less than or equal to about 5 mg KOH/g, preferably about 1 mg KOH/g, according to ASTM D664.

In any aspect or embodiment described herein, the reaction temperature ranges from about 80 to about 160° C., or about 100 to about 150° C., preferably from about 125 to about 145° C.

A further aspect of the present disclosure is curable compositions that include bio-based resin obtained from a reaction mixture comprising a glycidyl ether component and a bio-based component comprising a fatty acid and a rosin acid, wherein the glycidyl ether component comprises at least two epoxide groups; and an auxiliary epoxy resin. In any aspect or embodiment described herein, the auxiliary epoxy resin can be the same or different from the bisphenol epoxy resin of the glycidyl ether component. The auxiliary epoxy resin can be any epoxy resin known in the art. In any aspect or embodiment described herein, the auxiliary epoxy resin includes a bisphenol epoxy resin, a novolac epoxy resin, or a combination thereof. In any aspect or embodiment described herein, the ratio of bio-based resin to auxiliary epoxy resin in the curable compositions is about 20:80 to about 80:20, about 25:75 to about 75:25, about 30:70 to about 70:30, about 35:65 to about 65:35, about 40:60 to about 60:40, about 45:55 to about 55:45, or about 50:50.

In any aspect or embodiment described herein, the curable composition includes bisphenol A epoxy resin as the glycidyl ether component, and the bio-based component is a distilled tall oil comprising up to 50 wt %, from about 20 wt % to about 50 wt %, about 20 wt % to about 30 wt %, about 20 wt % to about 28 wt %, or about 28 wt % to about 50 wt % rosin acids, based on the total weight of the bio-based component.

In any aspect or embodiment described herein, the curable composition includes a mixture of bisphenol A epoxy resin and a novolac epoxy resin as the glycidyl ether component, and the distilled tall oil comprises up to about 50 wt %, about 20 wt % to about 50 wt %, about 20 wt % to about 30 wt %, about 20 wt % to about 28 wt %, or about 28 wt % to about 50 wt % rosin acids, based on the total weight of the distilled tall oil.

In any aspect or embodiment described herein, the curable composition includes a mixture of triglycidyl ether and novolac epoxy resin as the glycidyl ether component, and the distilled tall oil comprises up to 50 wt %, about 20 wt % to about 50 wt %, about 20 wt % to about 30 wt %, about 20 wt % to about 28 wt %, or about 28 wt % to about 50 wt % rosin acids, based on the total weight of the distilled tall oil.

In any aspect or embodiment described herein, the glycidyl ether component is trimethylolpropane triglycidyl ether, and the bio-based component is a distilled tall oil comprising about 50 wt % to about 70 wt % rosin acids, based on the total weight of the distilled tall oil.

In any aspect or embodiment described herein, the curable compositions further comprise an additive. In any aspect or embodiment described herein, the additive is a flow control agent, dry flow agent, antioxidant, pigment, dye, optical brightener, extender, heat stabilizer, light stabilizer, ultraviolet light stabilizer, ultraviolet light-absorbing compound, near infrared light-absorbing compound, infrared light-absorbing compound, plasticizer, lubricant, antistatic agent, anti-fog agent, antimicrobial agent, radiation stabilizer, flame retardant, anti-drip agent, fragrance, or a combination thereof. Any additive is used in an amount generally known to be effective, which can be from 0.001 to 10 parts by weight, per 100 parts by weight of the total amount of epoxy resin in the curable composition For example, in any aspect or embodiment described herein, the total amount of the additives (other than any filler or pigment) can be 0.01 to 20 parts by weight, or 1 to 10 parts by weight, per 100 parts by weight of the total amount of epoxy resin in the curable composition.

In any aspect or embodiment described herein, the curable compositions have a bio-content. In any aspect or embodiment described herein, the bio-content as used herein, refers to the weight of the bio-based component divided by the total weight of the composition. In any aspect or embodiment described herein, the bio-content is about 5 to about 40%, about 10 to about 35%. about 10 to about 30%, about 20 to about 40%, about 20 to about 35%, or about 20 to about 30%.

Methods for preparing the curable compositions include the steps of
a. admixing a glycidyl ether component and a bio-based component to form a reaction mixture;
b. heating the reaction mixture;
c. adding a catalyst to the reaction mixture;
d. allowing the reaction to proceed until the reaction mixture has an acid number of less than or equal to about 1 mg KOH/g according to ASTM D664;
e. adding the reaction mixture from step (d) to the auxiliary epoxy resin to form a mixture;
f. adding a curing agent to the mixture from step (e).

The term “curing agent” as used herein encompasses compounds whose roles in curing epoxy compounds are variously described as those of a hardener, a hardening accelerator, a crosslinking agent, a curing catalyst, a curing co-catalyst, and a curing initiator, among others. Curing agents can have active hydrogen atoms that react with epoxy groups of the epoxy resin to form an extended or cross-linked resin. The active hydrogen atoms can be present in functional groups comprising primary or secondary amines, phenols, thiols, carboxylic acids, or carboxylic acid anhydrides. Curing agents can also function as an initiator for epoxy resin polymerization or as an accelerator for other curing agents. In any aspect or embodiment described herein, the curing agents include imidazole, amines, organophosphine, urea derivatives, Lewis bases, and their organic salts, or a combination thereof.

The cured compositions of the present disclosure are useful for coatings, adhesives, composites, electronic encapsulations, and electrical potting materials.

In any aspect or embodiment described herein, the bio-based resins can be used to make polyurethanes. A urethane group is formed by the reaction between an alcohol and an isocyanate group. Thus, in any aspect or embodiment described herein, polyurethanes result from the reaction between an alcohol with two or more hydroxy groups (diol or polyol) and an isocyanate containing two or more isocyanate groups (diisocyanate or polyisocyanate). In any aspect or embodiment described herein, the bio-based resins used to make the polyurethanes is the reaction products of a glycidyl ether and a bio-based component, wherein the molar ratio of the glycidyl ether to the bio-based component is about 0.5:1 to about 1.5:1, or about 0.9:1 to about 1.1:1. In any aspect or embodiment described herein, the bio-based component has one hydroxyl group. In any aspect or embodiment described herein, the molar ratio of the glycidyl ether to the bio-based component is about 1:2. In any aspect or embodiment described herein, the bio-based resin has more than one hydroxyl group (i.e., “a polyol”).

In any aspect or embodiment described herein, in the synthesis of the polyurethanes, the bio-based resin is used in combination with additional polyols in the presence of a catalyst. In any aspect or embodiment described herein, the additional polyols include polyols derived from natural oils, caprolactone polyols, polyether polyols, polyester polyols, polycarbonate polyols, or a combination thereof.

As used herein “polyether polyols” are polymerization products of ethylene oxide, 1,2-propylene oxide, 1,2- or 2,3-butylene oxide, oxetane, tetrahydrofuran, or mixtures thereof, optionally polymerized with the aid of a starter molecule having two or more active hydrogen atoms, such as water, ammonia, for example, or compounds having two or more OH or NH groups (e.g., 1,2-ethanediol, 1,2- and 1,3-propanediol, neopentyl glycol, diethylene glycol, triethylene glycol, the isomeric dipropylene glycols and tripropylene glycols, the isomeric butanediols, pentanediols, hexanediols, heptanediols, octanediols, nonanediols, decanediols, undecanediols, 1,3- and 1,4-cyclohexanedimethanol, bisphenol A, hydrogenated bisphenol A, 1,1,1-trimethylolethane, 1,1,1-trimethylolpropane, glycerol, aniline, and mixtures of the stated compounds). In any aspect or embodiment described herein, polyether polyols include polyoxyethylene polyols and polyoxypropylene polyols, more particularly polyoxyethylene diols, polyoxypropylene diols, polyoxyethylene triols, polyoxypropylene triols, or a combination thereof.

As used herein “polyester polyols” are polyesters that carry at least two hydroxyl groups and are prepared by known processes (e.g., by the polycondensation of hydroxycarboxylic acids or the polycondensation of aliphatic and/or aromatic polycarboxylic acids with dihydric or polyhydric alcohols). In any aspect or embodiment described herein, polyester polyols include those prepared from di- to trihydric alcohols (e.g., 1,2-ethanediol, diethylene glycol, 1,2-propanediol, dipropylene glycol, 1,4-butanediol, 1,5-pentanediol, 1,6-hexanediol, neopentyl glycol, glycerol, 1,1,1-trimethylolpropane, or combinations thereof) with organic dicarboxylic acids or their anhydrides or esters (e.g., succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid, trimellitic acid, trimellitic anhydride, or combinations thereof). In any aspect or embodiment described herein, polyester diols include polyester diols prepared from adipic acid, azelaic acid, sebacic acid, dodecanedicarboxylic acid, dimer fatty acid, phthalic acid, isophthalic acid, terephthalic acid, or a combination thereof, as dicarboxylic acid. In any aspect or embodiment described herein, polycarbonate polyols include those obtainable by reaction, for example, of the foregoing alcohols used for synthesis of the polyester polyols, with a dialkyl carbonate (e.g., dimethyl carbonate), a diaryl carbonate (e.g. diphenyl carbonate), or phosgene.

In any aspect or embodiment described herein, the caprolactone polyols comprise a homopolymer, copolymer, or mixture thereof, obtainable by polymerizing a composition comprising caprolactone (e.g. ε-caprolactone) and then reacting the polycaprolactone with a chain extender. As used herein, the term “caprolactone” is intended to encompass unsubstituted caprolactone and substituted caprolactone. The term “ε-caprolactone” is intended to encompass unsubstituted ε-caprolactone and substituted ε-caprolactone. In any aspect or embodiment described herein, unsubstituted ε-caprolactone is particularly preferred.

As used herein, the term “caprolactone polyol” is intended to encompass homo-polymers and co-polymers obtainable by polymerization of a composition comprising caprolactone (e.g. ε-caprolactone). In any aspect or embodiment described herein, “caprolactone polyol” is intended to encompass a polymer obtainable by the homo- or co-polymerization of a composition comprising ε-caprolactone. In any aspect or embodiment described herein, co-polymerization may include the co-polymerization of caprolactone (e.g. ε-caprolactone) either with a co-monomer or diluent that is not a caprolactone, or with a mixture of different caprolactones (e.g. substituted and unsubstituted caprolactones or a mixture of caprolactones having different substituents).

In any aspect or embodiment described herein, substituted ε-caprolactone monomers used in the production of the caprolactone polyols include C₁₋₁₂ alkyl substituted ε-caprolactone, C₁₋₁₂ alkenyl substituted ε-caprolactone, C₁₋₁₂alkynyl substituted ε-caprolactone, C₁₋₁₈ cycloalkyl substituted ε-caprolactone, C₁₋₁₂ alkoxy substituted ε-caprolactone, C₁₋₁₈ aryl substituted ε-caprolactone, C₁₋₁₈ alkaryl substituted ε-caprolactone, C₁₋₁₈ aralkyl substituted ε-caprolactone, C₁₋₁₈ aryloxy substituted ε-caprolactone, or a mixture thereof.

In any aspect or embodiment described herein, substituted ε-caprolactone monomers used in the production of the caprolactone polyols include mono-substituted monomers, di-substituted monomers, tri-substituted monomers, or a mixture thereof. For example, in any aspect or embodiment described herein, substituted ε-caprolactone monomers include monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl εcaprolactone, dipropyl ε-caprolactone, dimethoxy ε-caprolactone, diethoxy ε-caprolactone, dipropoxy ε-caprolactone, dibenzyl ε-caprolactone, diphenyl ε-caprolactone, or a mixture thereof.

In any aspect or embodiment described herein, the polycaprolactone polyol is derived from caprolactone monomers and a chain extender. In any aspect or embodiment described herein, chain extenders include alkane diols, dialkylene glycols, polyalkylene polyols, crosslinking agents (e.g. trihydric alcohol, tetrahydric alcohol, oligomeric polyalkylene polyols, or a mixture thereof), or a mixture thereof.

In any aspect or embodiment described herein, a branched or straight chain, saturated or unsaturated C₂₋₁₂ alkane diol (e.g. branched or straight chain, saturated or unsaturated C₂₋₆ alkane diol) is used as chain extender compounds. In any aspect or embodiment described herein, the chain extender includes ethylene glycol, propane-1,3-diol, propane-1,2-diol, butane-1,4-diol, butane-1,3-diol, butane-1,2-diol, 2-butene-1,4-diol, 2,2-dimethylpropane-1,3-diol, hexane-1,6-diol, octane-1,8-diol, decane-1,10-diol, or a mixture thereof. Alternatively, in any aspect or embodiment described herein, C₄₋₈ dialkylene glycols (e.g. diethylene glycol and dipropylene glycol) as well as a polyoxyalkylene glycol, may be used as chain extenders.

In any aspect or embodiment described herein, the caprolactone polyol has a molecular weight in the range of 400 to 90000, more preferably 500 to 50000, more preferably, 540 to 5000. In any aspect or embodiment described herein, the caprolactone polyol produced by the esterification reaction has a polydispersity, measured by Gel Permeation Chromatography, of 1 to 2. Exemplary commercially available caprolactone polyols include CAPA 8025D, CAPA8015D, and CAPA2101, each available from INGEVITY.

Natural oils comprise triglycerides of saturated and unsaturated fatty acids. In any aspect or embodiment described herein, sources for polyols that are derived from natural oils include soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, or a combination thereof.

In any aspect or embodiment described herein, castor oil is a naturally occurring polyol that is used to make polyurethanes. Other natural oils need to be chemically modified to introduce sufficient hydroxyl content to make them useful in the production of polyurethane polymers. There are two chemically reactive sites that can be considered when attempting to modify natural oil or fat into a useful polyol: 1) the unsaturated sites (double bonds); and 2) the ester functionality. Unsaturated sites present in oil or fat can be hydroxylated via epoxidation/ring opening or hydroformylation/hydrogenation. Alternatively, trans-esterification can also be utilized to introduce OH groups in natural oil and fat.

In any aspect or embodiment described herein, the chemical process for the preparation of natural polyols using epoxidation involves a reaction mixture that requires epoxidized natural oil, a ring opening acid catalyst, and a ring opener. In any aspect or embodiment described herein, epoxidized natural oils include epoxidized plant-based oils (e.g., epoxidized vegetable oils), epoxidized animal fats, or a combination thereof. In any aspect or embodiment described herein, the epoxidized natural oils is fully or partially epoxidized and the oils include soybean oil, corn oil, sunflower oil, olive oil, canola oil, sesame oil, palm oil, rapeseed oil, tung oil, cotton seed oil, safflower oil, peanut oil, linseed oil, or a combination thereof. In any aspect or embodiment described herein, animal fats include fish, tallow, lard, or a combination thereof. These natural oils are triglycerides of fatty acids which may be saturated or unsaturated with various chain lengths from C12 to C24. These acids can be: 1) saturated: lauric, myristic, palmitic, steric, arachidic and lignoceric; 2) mono-unsaturated: palmitoleic, oleic, 3) poly-unsaturated: linoleic, linolenic, arachidonic.

In any aspect or embodiment described herein, partially or fully epoxidized natural oil is prepared when reacting peroxyacid under suitable reaction conditions. In any aspect or embodiment described herein, ring opening of the epoxidized oils with alcohols, water, and other compounds having one or multiple nucleophilic groups is used to generate the hydroxyl functionality. Ring opening yields natural oil polyol that can be used for the manufacture of polyurethanes.

In the hydroformylation/hydrogenation process, in any aspect or embodiment described herein, the oil is hydroformylated in a reactor filled with a hydrogen/carbon monoxide mixture in the presence of a suitable catalyst (e.g. cobalt or rhodium) to form an aldehyde which is hydrogenated in the presence of cobalt or nickel catalyst to form a polyol. Alternatively, in any aspect or embodiment described herein, polyol from natural oil and fats are produced by trans-esterification with a suitable poly-hydroxyl containing substance using an alkali metal or alkali earth metal base or salt as a trans-esterification catalyst. Any natural oil or alternatively any partially hydrogenated oil can be used in the transesterification process. For example, in any aspect or embodiment described herein, oils include, but are not limited to, soybean, corn, cottonseed, peanut, castor, sunflower, canola, rapeseed, safflower, fish, seal, palm, tung, olive oil, or any blend. In any aspect or embodiment described herein, any multifunctional hydroxyl compound is also used (e.g. lactose, maltose, raffinose, sucrose, sorbitol, xylitol, erythritol, mannitol, or a mixture thereof).

In addition to polyols, the polyurethanes are derived from isocyanates. In any aspect or embodiment described herein, the isocyanate is monomeric, oligomeric, polymeric, or a mixture thereof. For example, in any aspect or embodiment described herein, the isocyanate include 2,2′-, 2,4′- and 4,4′-diphenylmethane diisocyanate (MDI); 3,3′-dimethyl-4,4′-biphenylene diisocyanate (TODI); a toluene diisocyanate (TDI); a polymeric MDI; a modified liquid 4,4′-diphenylmethane diisocyanate; hexamethylene-diisocyanate (“HDI”); 4,4′dicyclohexylmethane diisocyanate (“Hu MDI”); isophorone diisocyanate (“IPDI”); para-phenylene diisocyanate (“PPDI”); meta-phenylene diisocyanate (“MPDI”); tetramethylene diisocyanate; dodecane diisocyanate; octamethylene diisocyanate; decamethylene diisocyanate; cyclobutane-1,3-diisocyanate; 1,2-, 1,3- and 1,4-cyclohexane diisocyanate; 2,4- and 2,6-methylcyclohexane diisocyanate; 4,4′- and 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′- and 2,4′-bis(isocyanatomethyl) dicyclohexane; isophorone diisocyanate; 2,4- and 2,6-hexahydrotoluenediisocyanate; 1,2-, 1,3- and 1,4-phenylene diisocyanate; triphenyl methane-4,4′,4″-triisocyanate; naphthylene-1,5-diisocyanate; 2,4′-, 4,4′- and 2,2-biphenyl diisocyanate; a polyphenyl polymethylene polyisocyanate (“PMDI”); meta-tetramethylxylene diisocyanate (“m-TMXDI”); para-tetramethylxylene diisocyanate (“p-TMXDI”); or a mixture thereof.

Any suitable urethane catalyst may be used for the preparation of the polyurethanes, including a tertiary amine compound, an amine with isocyanate reactive group(s), an organometallic compound, or a mixture thereof. In any aspect or embodiment described herein, the tertiary amine catalyst includes triethylenediamine, N-methylmorpholine, N, N-dimethylcyclohexylamine, pentamethyldiethylenetriamine, tetramethylethylenediamine, bis (dimethylaminoethyl) ether, 1-methyl-4-dimethylaminoethyl-piperazine, 3-methoxy-N-dimethylpropylamine, N-ethylmorpholine; dimethylethanolamine, N-cocomorpholine, N, N-dimethyl-N′, N′-dimethyl isopropylpropylenediamine, N, N-diethyl-3-diethyl amino-propylamine, dimethylbenzylamine, or a mixture thereof. In any aspect or embodiment described herein, the organometallic catalyst includes organobismuth, organo mercury, organolead, organoferric, organotin catalysts, or a combination thereof, with organotin catalysts being preferred among these. In any aspect or embodiment described herein, suitable tin catalysts include stannous chloride, tin salts of carboxylic acids such as dibutyltin dilaurate, and stannous octoate, as well as other organometallic compounds. In any aspect or embodiment described herein, a catalyst for the trimerization of polyisocyanates, resulting in a polyisocyanurate, such as an alkali metal alkoxide may also optionally be employed herein. In any aspect or embodiment described herein, the amount of amine catalyst is from 0.02 to 5 wt % of the reaction mixture. In any aspect or embodiment described herein, the amount of organometallic catalyst is from 0.001 to 1 wt % of the reaction mixture.

In any aspect or embodiment described herein, the polyurethanes are obtained from a reaction mixture comprising from about 1-99 wt % bio-based resin and about 1-99 wt % polyol.

In any aspect or embodiment described herein, the polyurethanes are obtained from a reaction mixture comprising about 50-99 wt % or about 65-95 wt % of a bio-based resin, and about 1-50 wt %, or about 5-35 wt % of a polycaprolactone polyol.

In any aspect or embodiment described herein, the polyurethanes are obtained from a reaction mixture comprising about 50-99 wt %, about 65-95 wt %, or about 60-90 wt % of a bio-based resin, and about 1-50 wt %, about 5-35 wt %, or about 10-30 wt % of castor oil.

In any aspect or embodiment described herein, the polyurethanes are obtained from a reaction mixture comprising about 50-99 wt % of a bio-based resin, and about 1-30 wt % of castor oil and about 1-20 wt % of a polycaprolactone polyol.

In any aspect or embodiment described herein, the polyurethanes of the present disclosure are useful as coatings or used as a coating in controlled release fertilizers and pesticides.

The details of the examples are contemplated as further embodiments of the described methods and compositions. Therefore, the details as set forth herein are hereby incorporated into the detailed description as alternative embodiments.

### EXAMPLES

### Synthesis Example 1

398 g of DTO M-50B (trade name: ALTAPYNE M-50B; from Ingevity; containing about 50% rosin acids and 50% tall oil fatty acids) and 364 g of trimethylolpropane triglycidyl ether (technical grade; from Sigma) are charged into a reaction vessel equipped with temperature probe, nitrogen inlet and mechanical stirrer. The reaction mixture is heated to 100° C. and then 1.6 g of triphenyl phosphine is charged. After the exothermic peak, the reaction mixture is cooled down to 125° C. and maintained at that temperature until an acid number ≤1 is reached. The reaction product is a viscous amber liquid with an EEW value of 623. The bio-content of this DTO-epoxy resin is about 52%.

### Synthesis Example 2

366 g of DTO M-50B (trade name: ALTAPYNE M-50B; from Ingevity; containing about 50% rosin acids and 50% tall oil fatty acids) and 415 g of bisphenol A diglycidyl ether (trade name: EPON 828; from Hexion) are charged into a reaction vessel equipped with temperature probe, nitrogen inlet and mechanical stirrer. The reaction mixture is heated to 100° C. and then 1.4 g of triphenyl phosphine (from Sigma) is charged. After the exothermic peak, the reaction mixture is cooled down to 125° C. and maintained at that temperature until an acid number ≤1 is reached. The reaction product is a viscous amber liquid with an EEW value of 690. The bio-content of this DTO-epoxy resin is about 47%.

### Synthesis Example 3

366 g of DTO M-28B (trade name: ALTAPYNE M-28B; from Ingevity; containing about 28% rosin acids and 78% tall oil fatty acids) and 463 g of bisphenol A diglycidyl ether (trade name: EPON 828; from Hexion) are charged into a reaction vessel equipped with temperature probe, nitrogen inlet and mechanical stirrer. The reaction mixture is heated to 100° C. and then 1.4 g of triphenyl phosphine (from Sigma) is charged. After the exothermic peak, the reaction mixture is cooled down to 125° C. and maintained at that temperature until an acid number ≤1 is reached. The reaction product is a viscous amber liquid with an EEW value of 666. The bio-content of this DTO-epoxy resin is about 44%.

### Synthesis Example 4

366 g of DTO M-28B (trade name: ALTAPYNE M-28B; from Ingevity; containing about 28% rosin acids and 78% tall oil fatty acids), 225 g of trimethylolpropane triglycidyl ether (technical grade; from Sigma) and 280 g of Epoxy Novolac Resin (trade name: D.E.N. 438; from Olin) are charged into a reaction vessel equipped with temperature probe, nitrogen inlet and mechanical stirrer. The reaction mixture is heated to 100° C. and then 1.4 g of triphenyl phosphine (from Sigma) is charged. After the exothermic peak, the reaction mixture is cooled down to 125° C. and maintained at that temperature until an acid number ≤1 is reached. The reaction product is a viscous amber liquid with an EEW value of 463. The bio-content of this DTO-epoxy resin is about 41%.

### Synthesis Example 5

337 g of DTO M-28B (trade name: ALTAPYNE M-28B; from Ingevity; containing about 28% rosin acids and 78% tall oil fatty acids), 258 g of Epoxy Novolac Resin (trade name: DEN 438; from Olin) and 258 g of bisphenol A diglycidyl ether (trade name: EPON 828; from Hexion) are charged into a reaction vessel equipped with temperature probe, nitrogen inlet and mechanical stirrer. The reaction mixture is heated to 100° C. and then 1.3 g of triphenyl phosphine (from Sigma) is charged. After the exothermic peak, the reaction mixture is cooled down to 125° C. and maintained at that temperature until an acid number ≤1 is reached. The reaction product is a viscous amber liquid with an EEW value of 502. The bio-content of this DTO-epoxy resin is about 42%.

### Example 6

A simple model formula was used to evaluate the performance of the DTO-epoxy resins synthesized above and EPON 828 was used as the control. In this formula, the DTO-epoxy resins were first mixed with EPON 828 in different ratios, and then mixed with a curing agent (Jeffamine T403) in a 1:1 equivalent ratio, together with 5 wt % (on the total weight of epoxy and curing agent) of 2,4,6-Tris-(dimethylaminomethyl)phenol (DMP-30) as an accelerator (catalyst).

In a curing behavior study, 150 g of the above mixture in a plastic cup was placed in a 50° C. water bath and the viscosity, gel time, time from gel to exothermic peak temperature and peak temperature were recorded. The viscosity of the mixture was measured with a Brookfield viscometer (model CAP 2000+) at 50° C. and 50 rpm with a #3 spindle. The above mixture was also poured into the silicon molds to cure at room temperature overnight and then post-cure at 100° C. for 2 hours to prepare specimens for tensile test and dynamic mechanical analysis (DMA). The model formula for coating properties study was prepared by mixing 80 parts of the above mixture with 20 parts of methyl ethyl ketone (MEK). Standard test panels were made by applying the epoxy coatings to Leneta cards and aluminum panels using a drawdown bar. The coatings on test panels were cured for 7 days at room temperature (25° C.) before the coating property characterization. ASTM methods were used for sample characterization where applicable. The dry time was recorded with a GARDCO DT-5040 quadracycle electronic dry time recorder (ASTM D5895).

The methyl ethyl ketone (MEK) double rub test was conducted with a ball-peen hammer (ASTM D5402).

The gloss of the coated films was measured with a BYK gloss meter.

The pencil hardness test was conducted with a BYK pencil hardness tester according to ASTM D3363.

The mandrel bend test was conducted with a TQC mandrel bend tester (ASTM D522).

The adhesion of the coatings to aluminum was measured with the cross-hatch tape test method (ASTM D3359). The water absorption test was conducted by immersing the samples in water at room temperature and measure the weight gain of each sample at 3 days and 7 days. The chemical resistance of the coatings was evaluated with a spot test method by placing a drop of each of the chemicals on the coating surface and evaluating the damage to the contact area after 24 hours in contact. The damage was rated in 1 to 5 scale (5: no damage; 4: slight damage; 3: moderate damage; 2: considerable damage; 1: Very strong damage). The properties of the samples were listed in Tables 1 and 2.

TABLE 1
Properties of 50/50 mixtures of EPON 828/DTO Epoxy

| Example No. | Control | 1 | 2 | 3 | 4 | 5 |
|---|---|---|---|---|---|---|
| DTO-epoxy | | Synthesis | Synthesis | Synthesis | Synthesis | Synthesis |
| | | Example 1 | Example 2 | Example 3 | Example 4 | Example 5 |
| Mix ratio of | 100/0 | 50/50 | 50/50 | 50/50 | 50/50 | 50/50 |
| Epon828/DTO | | | | | | |
| epoxy | | | | | | |
| Bio-content, % | 0 | 26 | 24 | 22 | 21 | 20 |
| Process Properties | | | | | | |
| Initial | 60 | 210 | 530 | 310 | 270 | 420 |
| viscosity | | | | | | |
| @50, cps | | | | | | |
| Gel time | 54 | 34 | 27 | 31 | 30 | 30 |
| @50 C., min | | | | | | |
| Cure Time | 9 | 12 | 10 | 11 | 13 | 14 |
| @50 C., min | | | | | | |
| Exothermic | 154 | 130 | 129 | 122 | 141 | 126 |
| peak | | | | | | |
| temperature, ° C. | | | | | | |
| Thermal and Physical properties | | | | | | |
| Tan Delta | 98 | 56 | 82 | 73 | 74 | 80 |
| Tg ° C. | | | | | | |
| Tensile | 65.4 ± | 41.8 ± | 51.4 ± | 49.3 ± | 50.2 ± | 53.7 ± |
| strength, | 4.4 | 2.7 | 9.8 | 7.8 | 3.5 | 1.5 |
| Mpa | | | | | | |
| Tensile | 3477.7 ± | 2501.1 ± | 3413.0 ± | 2944.4 ± | 2731.7 ± | 2818.5 ± |
| modulus, | 116.4 | 113.0 | 402.9 | 80.4 | 244.9 | 85.8 |
| Mpa | | | | | | |
| Elongation | 3.39 ± | 3.92 ± | 1.70 ± | 2.18 ± | 3.15 ± | 2.86 ± |
| at break, % | 0.59 | 0.51 | 0.17 | 0.52 | 0.31 | 0.30 |
| Coating properties (room temperature cured) | | | | | | |
| Circular | 5.7 | 9.2 | 6.8 | 7.2 | 6.5 | 6.2 |
| tack free | | | | | | |
| time, hr | | | | | | |
| 60° Gloss | 101 | 98 | 100 | 100 | 99 | 100 |
| Pencil | 2H | HB | HB | HB | H | H |
| hardness | | | | | | |
| Conical | Pass | Pass | Fail | Pass | Pass | Pass |
| mandrel | | | | | | |
| bend | | | | | | |
| Cross hatch | 3B | 5B | 2B | 4B | 4B | 5B |
| adhesion to | | | | | | |
| Aluminum | | | | | | |
| MEK | 300 | 225 | 150 | 250 | 275 | 300 |
| resistance, | | | | | | |
| double rubs | | | | | | |
| Chemical resistance (24 hours spot test, 5- no damage, 1 - strong damage) | | | | | | |
| Acetic acid | 1 | 1 | 1 | 1 | 1 | 1 |
| (10%) | | | | | | |
| Sulfuric | 2 | 1 | 2 | 2 | 2 | 2 |
| acid (50%) | | | | | | |
| Sodium | 5 | 5 | 5 | 5 | 5 | 5 |
| hydroxide | | | | | | |
| (50%) | | | | | | |
| Ammonium | 5 | 5 | 5 | 5 | 5 | 5 |
| hydroxide | | | | | | |
| (10%) | | | | | | |
| Xylene | 5 | 5 | 5 | 5 | 5 | 5 |
| Water Absorption (%) | | | | | | |
| 25° C./3 days | 0.45 | 2.38 | 0.94 | 1.06 | 1.5 | 0.89 |
| 25° C./7 days | 0.73 | 3.8 | 1.45 | 1.73 | 2.3 | 1.47 |

TABLE 2
Properties of 75/25 - 25/75 mixtures of EPON 828/DTO Epoxy

| Example No. | Control | 6 | 2 | 7 | 4 | 8 | 9 | 5 | 10 |
|---|---|---|---|---|---|---|---|---|---|
| DTO | | Synthesis | | Synthesis | | | Synthesis | | |
| epoxy | | Example 3 | | Example 4 | | | Example 5 | | |
| Ratio of | 100/0 | 75/25 | 50/50 | 75/25 | 50/50 | 25/75 | 75/25 | 50/50 | 25/75 |
| EPON8 | | | | | | | | | |
| 28/DTO | | | | | | | | | |
| epoxy | | | | | | | | | |
| Bio-content, | 0 | 12 | 24 | 11 | 21 | 32 | 10 | 20 | 30 |
| (%) | | | | | | | | | |

Process Properties

| | | | | | | | | | |
|---|---|---|---|---|---|---|---|---|---|
| Initial | 60 | 350 | 530 | 150 | 270 | 480 | 180 | 420 | 780 |
| Mix | | | | | | | | | |
| viscosity | | | | | | | | | |
| @50 C., | | | | | | | | | |
| cps | | | | | | | | | |
| Gel time | 54 | 37 | 27 | 31 | 30 | 28 | 37 | 30 | 27 |
| @50 C., | | | | | | | | | |
| min | | | | | | | | | |
| Cure time | 9 | 13 | 10 | 11 | 13 | 16 | 12 | 14 | 15 |
| @50 C., | | | | | | | | | |
| min | | | | | | | | | |
| Exothermic | 154 | 152 | 129 | 122 | 141 | 109 | 160 | 126 | 108 |
| peak temp, | | | | | | | | | |
| ° C. | | | | | | | | | |

Thermal and Physical Properties

| | | | | | | | | | |
|---|---|---|---|---|---|---|---|---|---|
| Tan | 98 | 91 | 82 | 73 | 74 | too | 95 | 80 | 69 |
| Delta | | | | | | soft | | | |
| Tg° C. | | | | | | | | | |
| Tensile | 65.4 ± | 59.9 ± | 51.4 ± | 58.4 ± | 50.2 ± | 16.0 ± | 60.2 ± | 53.7 ± | 40.1 ± |
| strength, Mpa | 4.4 | 10.1 | 9.8 | 4.6 | 3.5 | 0.7 | 2.1 | 1.5 | 2.6 |
| Tensile | 3477.7 ± | 3304.0 ± | 3413.0 ± | 3213.6 ± | 2731.7 ± | 906.6 ± | 3217.4 ± | 2818.5 ± | 2212.4 ± |
| modulus, | 116.4 | 117.9 | 402.9 | 380.9 | 244.9 | 66.8 | 124.0 | 85.8 | 189.9 |
| Mpa | | | | | | | | | |
| Elongation at | 3.39 ± | 3.04 ± | 1.70 ± | 3.61 ± | 3.15 ± | 16.12 ± | 2.80 ± | 2.86 ± | 2.97 ± |
| break, % | 0.59 | 0.57 | 0.17 | 0.31 | 0.31 | 3.56 | 0.25 | 0.30 | 0.30 |

Coating properties

| | | | | | | | | | |
|---|---|---|---|---|---|---|---|---|---|
| Circular | 5.7 | 5.9 | 6.8 | 6.0 | 6.5 | 7.5 | 5.7 | 6.2 | 7.0 |
| Tack-free | | | | | | | | | |
| time, min | | | | | | | | | |
| 60° | 101 | 100 | 100 | 100 | 99 | 97 | 100 | 100 | 99 |
| Gloss | | | | | | | | | |
| Pencil | 2H | H | HB | H | H | 3B | H | H | HB |
| hardness | | | | | | | | | |
| Conical | pass | fail | fail | pass | pass | pass | pass | pass | pass |
| Mandrel | | | | | | | | | |
| mixture | | | | | | | | | |
| Cross hatch | 3B | 2B | 2B | 3B | 4B | 4B | 5B | 5B | 5B |
| adhesion to | | | | | | | | | |
| aluminum | | | | | | | | | |
| MEK | 300 | 300 | 150 | >400 | 275 | 125 | 325 | 300 | 150 |
| resistance, | | | | | | | | | |
| double rubs | | | | | | | | | |

Chemical resistance

| | | | | | | | | | |
|---|---|---|---|---|---|---|---|---|---|
| Acetic | 1 | 1 | 1 | 1 | 1 | 1 | 1 | 1 | 1 |
| acid (10%) | | | | | | | | | |
| Sulfuric | 2 | 2 | 2 | 2 | 2 | 1 | 2 | 2 | 2 |
| acid (50%) | | | | | | | | | |
| Sodium | 5 | 5 | 5 | 5 | 5 | 5 | 5 | 5 | 5 |
| hydroxide | | | | | | | | | |
| (50%) | | | | | | | | | |
| Ammonium | 5 | 5 | 5 | 5 | 5 | 5 | 5 | 5 | 5 |
| hydroxide | | | | | | | | | |
| (10%) | | | | | | | | | |
| Xylene | 5 | 5 | 5 | 5 | 5 | 5 | 5 | 5 | 5 |

Water Absorption (%)

| | | | | | | | | | |
|---|---|---|---|---|---|---|---|---|---|
| 25° C./3 | 0.45 | 0.42 | 0.94 | 0.97 | 1.5 | 3.45 | 0.48 | 0.89 | 1.08 |
| days | | | | | | | | | |
| 25° C./7 | 0.73 | 0.65 | 1.45 | 1.5 | 2.2 | 5.34 | 0.82 | 1.47 | 1.66 |
| days | | | | | | | | | |

### Synthesis Example 8

2319 g of DTO M-28B (trade name: ALTAPYNE M-28B; from Ingevity; containing about 28% rosin acids and 78% tall oil fatty acids) and 1500 g of bisphenol A diglycidyl ether (trade name: EPON 828; from Hexion) are charged into a reaction vessel equipped with temperature probe, nitrogen inlet and mechanical stirrer. The molar ratio of bisphenol A diglycidyl ether to the biobased component is about 1:2, so that each glycidyl ether group reacts with a carboxylic acid group (i.e., rosin acid and/or fatty acid). The reaction mixture is heated to 100° C. and then 5 g of triphenyl phosphine (from Sigma) is charged. After the exothermic peak, the reaction mixture is cooled down to 130° C. and maintained at that temperature until an acid number ≤0.5 is reached. The reaction product is a diol with a hydroxyl value about 120. The bio-content of this DTO-based diol resin is about 60%.

### Synthesis Example 9

1276 g of DTO M-50B (trade name: ALTAPYNE M-50B; from Ingevity; containing about 50% rosin acids and 50% tall oil fatty acids) and 800 g of bisphenol A diglycidyl ether (trade name: EPON 828; from Hexion) are charged into a reaction vessel equipped with temperature probe, nitrogen inlet and mechanical stirrer. The molar ratio of bisphenol A diglycidyl ether to the biobased component is about 1:2, so that each glycidyl ether group reacts with a carboxylic acid group (i.e., rosin acid and/or fatty acid). The reaction mixture is heated to 100° C. and then 3.1 g of triphenyl phosphine is charged. After the exothermic peak, the reaction mixture is cooled down to 130° C. and maintained at that temperature until an acid number ≤0.5 is reached. The reaction product is a diol with a hydroxyl value about 120. The bio-content of this DTO-based diol resin is about 61%.

### Example 10

DTO polyols prepared according to Synthesis Examples 8 and 9 were combined with other synthetic polyols (such as Ingevity CAPA series caprolactone polyols) and/or natural polyols (such as castor oil) in different ratios to be used in polyurethane synthesis to achieve balanced properties in terms of glass transition temperature (Tg), flexibility and hydrophobicity. The isocyanate used was polymeric diphenylmethane diisocyanate isocyanate (PAPI 2027 from Sigma, average Mn˜340). The molar ratio of isocyanate groups to hydroxyl groups was 1.1. Polyurethane samples for performance evaluation was prepared by first mixing the polyol components at room temperature or elevated temperature (for polyols with higher viscosity and/or higher Tg). The polyol mixture was then mixed with PAPI 2027 and poured into silicon molds to cure in an 80° C. oven for 30 minutes.

The DMA test was conducted using a 3-point bending geometry on a TA Instruments DHR-2 rheometer at a heating rate of 2° C./minute and the tan delta curve maximum was used as the sample Tg. The tensile test was performed on an Instron 3365 universal testing machine at a crosshead speed of 10 mm/minute on rectangle polyurethane film samples (80 mm×20 mm×2 mm).

The water absorption test was carried out by immersing a polyurethane sample (44 mm×13 mm×3 mm in dimension) in water at room temperature. At different time intervals, the sample was taken out and water on the sample surface was wiped off before measuring the weight gain. The water absorption percentage after t days of water immersion was calculated as:

$$Water absorption ( \% ) = \frac{{M}_{t} - {M}_{0}}{{M}_{0}} ⨯ 100 \%$$

where M₀ and M₁ are the initial sample weight and the sample weight after t days of water immersion, respectively.

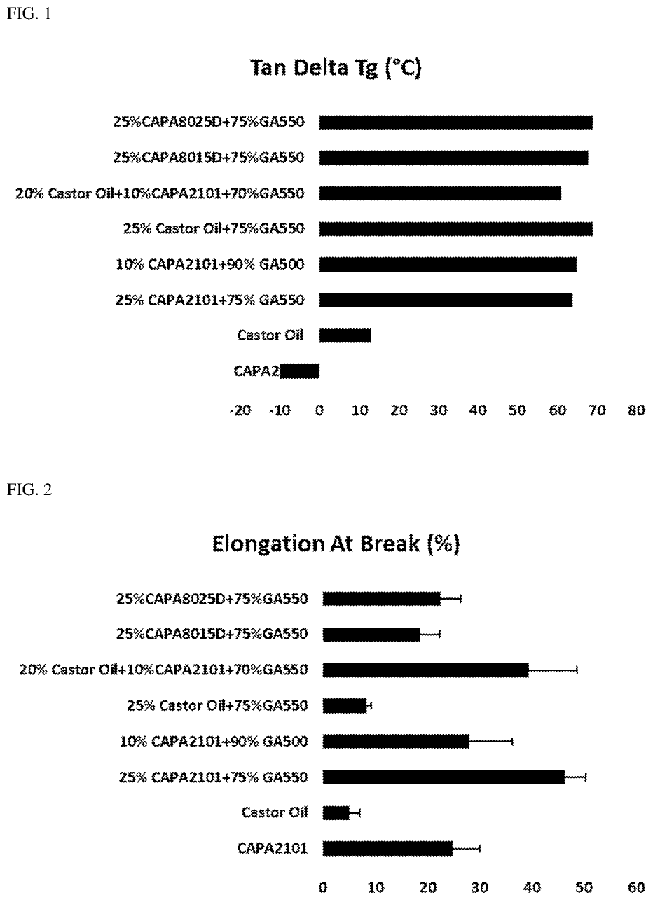

The Tg, water absorption and tensile test results based on the different polyol combinations are listed in Tables 3-4. With increasing the content of repeating units derived from the bio-based resins in the formulation, the resulting polyurethane films show higher Tg and lower water absorption. As shown in FIG. 1, those polyurethane samples that include repeating units derived from the bio-based resins have improved Tg values (e.g., greater than 60° C.) as compared with the polyurethane samples based on castor oil or CAPA 2101.

The tensile test was performed on an Instron 3365 universal testing machine at a crosshead speed of 10 mm/minute on rectangle polyurethane film samples (80 mm×20 mm×2 mm). The Young's modulus, tensile strength and elongation at break values were recorded and exhibited in Table 3. The elongation at break values of the polyurethanes based on different polyol combinations in FIG. 2 shows that both the polyurethane film having a combination of 20% of castor oil, 10% of CAPA 2101 and 70% of GA-550 and a film having a combination of 25% CAPA 2101 and 75% GA-550, each have every good flexibility (−40% in elongation at break). They also have Tg over 60° C.

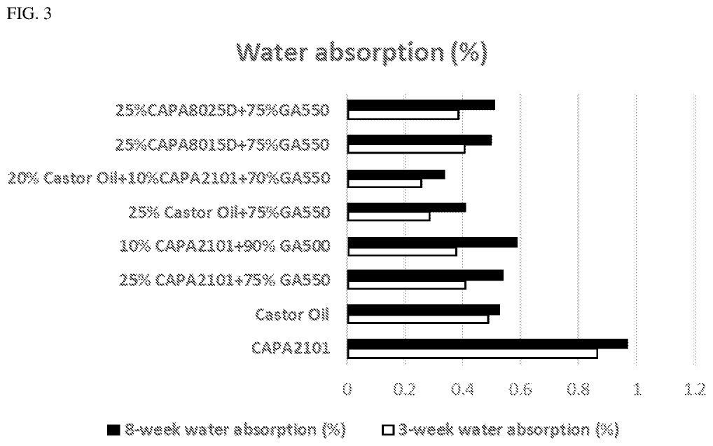

FIG. 3 shows the comparison of the water absorption behavior of the polyurethane compositions after 3 weeks and 8 weeks of water immersion. Compared with the polyurethane samples that are based on the formulations without DTO diols, the polyurethane samples based on the formulations with DTO diols all show lower water absorption, suggesting an improvement in water resistance. Overall, the polyurethane sample based on a combination of 20% of castor oil, 10% of CAPA 2101 and 70% of GA-550 shows the lowest water absorption among all the tested samples, besides its high Tg (>60° C.) and good flexibility (˜40% in elongation at break).

TABLE 3
Polyurethanes 1-11

| Experiment No. | | 1 | 2 | 3 | 4 | 5 | 6 | 7 | 8 | 9 | 10 | 11 |
|---|---|---|---|---|---|---|---|---|---|---|---|---|
| | Castor | 100% | | | | | | | | | | 25% |
| | oil | | | | | | | | | | | |
| CAPA | CAPA | | 100% | | 25% | 50% | 75% | 10% | 25% | 50% | 75% | |
| Diols | 2101 | | | | | | | | | | | |
| | CAPA | | | | | | | | | | | |
| | 8015D | | | | | | | | | | | |
| | CAPA | | | | | | | | | | | |
| | 8025D | | | | | | | | | | | |
| DTO | GA- | | | | | | | 90% | 75% | 50% | 25% | 75% |
| Diols | 500 | | | | | | | | | | | |
| | GA- | | | | 75% | 50% | 25% | | | | | |
| | 550 | | | | | | | | | | | |
| DMA | (° C.) | 13 | −10 | −2 | 64 | 43 | 9 | 65 | 50 | 31 | 3 | 58 |
| Tg | | | | | | | | | | | | |
| Water | | | | | | | | | | | | |
| absorption | | | | | | | | | | | | |
| (%) | | | | | | | | | | | | |
| 3 weeks | | 0.49 | 0.86 | 0.97 | 0.41 | 0.52 | 0.64 | 0.38 | 0.43 | 0.56 | 0.72 | 0.36 |
| 8 weeks | | 0.53 | 0.97 | 0.96 | 0.54 | 0.64 | 0.72 | 0.59 | 0.61 | 0.72 | 0.76 | 0.54 |
| Tensile | | | | | | | | | | | | |
| properties | | | | | | | | | | | | |
| Modulus | (Mpa) | 130 ± | 5.66 ± | — | 600 ± | 5.72 ± | 4.33 ± | 720.82 ± | 26.67 ± | 4.26 ± | — | 506.43 ± |
| | | 24 | 0.10 | | 3 1 | 0.98 | 0.23 | 43.28 | 1.39 | 0.04 | | 23.21 |
| Tensile | (Mpa) | 0.95 ± | 1.08 ± | — | 16.47 ± | 5.25 ± | 1.75 ± | 23.00 ± | 7.58 ± | 3.22 ± | — | 13.45 ± |
| strength | | 0.12 | 0.19 | | 1.69 | 0.83 | 0.14 | 1.51 | 0.17 | 0.31 | | 1.38 |
| Elongation | (%) | 3.55 ± | 24.88 ± | — | 46.25 ± | 125.07 ± | 63.02 ± | 28.00 ± | 66.35 ± | 123.83 ± | — | 21.40 ± |
| | | 1.41 | 5.17 | | 4.12 | 11.46 | 5.25 | 8.29 | 4.06 | 8.78 | | 9.43 |

TABLE 4
Polyurethanes 12-21

| Experiment No. | | 12 | 13 | 14 | 15 | 16 | 17 | 18 | 19 | 20 | 21 |
|---|---|---|---|---|---|---|---|---|---|---|---|
| | Castor | 25% | 50% | 75% | 20% | 25% | 50% | 50% | 75% | | |
| | oil | | | | | | | | | | |
| CAPA | CAPA | | | | 10% | 25% | 25% | 50% | 25% | | |
| Diols | 2101 | | | | | | | | | | |
| | CAPA | | | | | | | | | 25% | |
| | 8015D | | | | | | | | | | |
| | CAPA | | | | | | | | | | 25% |
| | 8025D | | | | | | | | | | |
| DTO | GA- | | | | | | | | | | |
| Diols | 500 | | | | | | | | | | |
| | GA- | 75% | 50% | 25% | 70% | 50% | 25% | | | 75% | 75% |
| | 550 | | | | | | | | | | |
| DMA Tg | (° C.) | 69 | 50 | 24 | 61 | 42 | 22 | −1 | 6 | 68 | 69 |
| Water | | | | | | | | | | | |
| absorption | | | | | | | | | | | |
| (%) | | | | | | | | | | | |
| 3 weeks | | 0.29 | 0.23 | 0.37 | 0.26 | 0.44 | 0.41 | 0.45 | 0.55 | 0.41 | 0.39 |
| 8 weeks | | 0.41 | 0.32 | 0.44 | 0.34 | 0.54 | 0.43 | 0.53 | 0.65 | 0.5 | 0.51 |
| Tensile | | | | | | | | | | | |
| properties | | | | | | | | | | | |
| Modulus | (Mpa) | 1076 ± | 154.30 ± | 104.22 ± | 695.29 ± | 8.26 ± | 6.17 ± | — | 6.82 ± | 983 ± | 711 ± |
| | | 26 | 17.66 | 16.70 | 45.34 | 0.40 | 0.18 | | 0.13 | 69 | 85 |
| Tensile | (Mpa) | 35.59 ± | 11.08 ± | 1.59 ± | 22.43 ± | 5.39 ± | 1.77 ± | — | 1.39 ± | 33.60 ± | 25.15 ± |
| strength | | 3.35 | 0.63 | 0.18 | 1.17 | 0.81 | 0.06 | | 0.05 | 2.97 | 3.56 |
| Elongation | (%) | 8.32 ± | 35.23 ± | 8.34 ± | 39.40 ± | 87.54 ± | 40.27 ± | — | 26.30 ± | 18.61 ± | 22.5 ± |
| | | 0.82 | 2.70 | 3.97 | 9.27 | 10.3 | 2.19 | | 0.83 | 3.63 | 3.91 |

### EXEMPLARY EMBODIMENTS

In any aspect or embodiment described herein, a bio-based resin is obtained from a reaction mixture comprising a glycidyl ether component and a bio-based component comprising a fatty acid and a rosin acid, wherein the glycidyl ether component comprises at least two epoxide groups.

In any aspect or embodiment described herein, the bio-based resin comprises a fatty acid derived from at least one soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, or a combination thereof. In any aspect or embodiment described herein, the bio-based resin comprises a rosin acid comprising at least one gum rosin acid, wood rosin acid, tall oil rosin acid, or a combination thereof. In any aspect or embodiment described herein, the glycidyl ether component comprises a bisphenol epoxy resin, a novolac epoxy resin, a diglycidyl ether, triglycidyl ether, tetraglycidyl ether, or a combination thereof.

In any aspect or embodiment described herein, the bisphenol epoxy resin comprises bisphenol A epoxy resin, bisphenol F epoxy resin, or a combination thereof.

In any aspect or embodiment described herein, the diglycidyl ether comprises a diglycidyl ether of neopentyl glycol, a diglycidyl ether of 1,4-butanediol, diglycidyl ether of resorcinol, or a combination thereof. In any aspect or embodiment described herein, the triglycidyl ether comprises trimethylolpropane triglycidyl ether. In any aspect or embodiment described herein, the tetraglycidyl ether comprises pentaerythritol tetraglycidyl ether.

In any aspect or embodiment described herein, the novolac epoxy resin comprises epoxy phenol novolac, epoxy cresol novolac, or a combination thereof, and wherein the novolac epoxy resin has an epoxy functionality of 3-6.

In any aspect or embodiment described herein, the bio-based component further comprises fatty acid derivatives, rosin acid derivatives, or a combination thereof.

In any aspect or embodiment described herein, the fatty acid derivatives comprise dimer fatty acids, acrylic acid modified fatty acids, maleic anhydride modified fatty acids, or a combination thereof.

In any aspect or embodiment described herein, the rosin acid derivatives comprise hydrogenated rosins, disproportionated rosins, maleic anhydride modified rosins, fumaric acid modified rosins, or a combination thereof.

In any aspect or embodiment described herein, the bio-based component comprises about to about 99 wt % of fatty acids. In any aspect or embodiment described herein, the bio-based component comprises about 1 to about 99 wt % of rosin acids.

In any aspect or embodiment described herein, a molar ratio of the glycidyl ether to the bio-based component is about 0.5:1 to about 1.5:1, or about 0.9:1 to about 1.1:1.

In any aspect or embodiment described herein, a molar ratio of the glycidyl ether to the bio-based component is about 1:1.5 to about 1:2.5, or about 1:1.8 to about 1:2.2.

In any aspect or embodiment described herein, a molar ratio of the glycidyl ether to the bio-based component is about 1:2.

In any aspect or embodiment described herein, the glycidyl ether component is bisphenol A epoxy resin, and the bio-based component is a distilled tall oil comprising up to about 50 wt % rosin acids, based on the total weight of the distilled tall oil.

In any aspect or embodiment described herein, the glycidyl ether component is a bisphenol A epoxy resin and a novolac epoxy resin, and the bio-based component is a distilled tall oil comprising up to about 50 wt % rosin acids, based on the total weight of the distilled tall oil.

In any aspect or embodiment described herein, the glycidyl ether component is a triglycidyl ether and a novolac epoxy resin, and the bio-based component is a distilled tall oil comprising up to about 50 wt % rosin acids, based on the total weight of the distilled tall oil.

In any aspect or embodiment described herein, the glycidyl ether component is a trimethylolpropane triglycidyl ether, and bio-based component is a distilled tall oil comprising from about 50 wt % to about 70 wt % rosin acid, based on the total weight of the distilled tall oil.

In any aspect or embodiment described herein, a curable composition comprises: a bio-based resin obtained from a reaction mixture comprising a glycidyl ether component and a bio-based component comprising a fatty acid and a rosin acid, wherein the glycidyl ether component comprises at least two epoxide groups; and an auxiliary epoxy resin.

In any aspect or embodiment described herein, a ratio of bio-based resin to auxiliary epoxy resin is about 10:90 to about 90:10, about 25:75 to about 75:25, or about 50:50.

In any aspect or embodiment described herein, the glycidyl ether component is a bisphenol A epoxy resin, and the bio-based component is a distilled tall oil comprising up to about 50 wt % rosin acids. In any aspect or embodiment described herein, the glycidyl ether component is a mixture of bisphenol A epoxy resin and a novolac epoxy resin, and the bio-based component is a distilled tall oil comprising up to about 50 wt % rosin acids. In any aspect or embodiment described herein, the glycidyl ether component is a mixture of triglycidyl ether and novolac epoxy resin, and the bio-based component is a distilled tall oil comprising up to about 50 wt % rosin acids, each based on the total weight of the distilled tall oil.

In any aspect or embodiment described herein, a method of preparing the bio-based resin comprises the steps of
a. admixing a glycidyl ether component and a bio-based component to form a reaction mixture;
b. heating the reaction mixture;
c. adding a catalyst to the reaction mixture; and
d. allowing reaction to proceed until the reaction mixture has an acid number of less than or equal to about 1 mg KOH/g according to ASTM D664.

In any aspect or embodiment described herein, a method of preparing the curable composition comprises the steps of
a. admixing a glycidyl ether component and a bio-based component to form a reaction mixture;
b. heating the reaction mixture;
c. adding a catalyst to the reaction mixture;
d. allowing the reaction to proceed until the reaction mixture has an acid number of less than or equal to about 1 mg KOH/g according to ASTM D664;
e. adding the reaction mixture from step (d) to an auxiliary epoxy resin to form a mixture;
f. adding a curing agent to the mixture from step (e).

In any aspect or embodiment described herein, a polyurethane comprises repeating units derived from the bio-based resin.

In any aspect or embodiment described herein, a polyurethane comprises repeating units derived from the bio-based resin wherein the molar ratio of the glycidyl ether to the bio-based component is about 1:2 in the reaction mixture for obtaining the bio-based resin.

In any aspect or embodiment described herein, a polyurethane comprises repeating units derived from a polyether polyol, a polyester polyol, a polycaprolactone polyol, a polyol derived from a natural oil, or a combination thereof.

In any aspect or embodiment described herein, a polyurethane comprises repeating units derived from a monomeric, an oligomeric, or a polymeric isocyanate.

In any aspect or embodiment described herein, the polyol derived from a natural oil is derived from at least one of soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, or a combination thereof.

While several embodiments of the invention have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference. For example, U.S. patent application Ser. No. 17/085,016, filed on 30 Oct. 2020 and published as U.S. Patent Application Publication No. 2021/0139640 A1, which claims the benefit of and priority to U.S. Provisional Application No. 62/932,600, filed on 8 Nov. 2019, each of which are incorporated by reference herein in their entirety for all purposes.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

What is claimed is:

1. A bio-based resin obtained from a reaction mixture comprising a glycidyl ether component and a bio-based component comprising a fatty acid and a rosin acid, wherein the glycidyl ether component comprises at least two epoxide groups.

2. The bio-based resin according to claim 1, wherein:
the fatty acid is derived from soybean oil, canola oil, tall oil, safflower oil, linseed oil, castor oil, corn oil, sunflower oil, olive oil, sesame oil, cottonseed oil, palm-based oils, rapeseed oil, tung oil, peanut oil, jatropha oil, or a combination thereof;
the rosin acid comprises gum rosin acid, wood rosin acid, tall oil rosin acid, or a combination thereof;
the glycidyl ether component comprises a bisphenol epoxy resin, a novolac epoxy resin, a diglycidyl ether, triglycidyl ether, tetraglycidyl ether, or a combination thereof;
the bio-based component comprises 1-99 wt % of fatty acids and 1-99 wt % of rosin acids; or a combination thereof.

3. The bio-based resin according to claim 1, wherein the bio-based resin has an acid number of less than or equal to about 5 milligrams of KOH per gram according to ASTM D664; an epoxide equivalent weight of about 200 to about 800 grams per equivalent; or a combination thereof.

4. The bio-based resin according to claim 1, wherein the bio-based resin has an acid number of less than or equal to about 5 milligrams of KOH per gram according to ASTM D664; an epoxide equivalent weight of greater than about 5,000 grams per equivalent; or a combination thereof.

5. The bio-based resin according to claim 2, wherein:
the bisphenol epoxy resin comprises bisphenol A epoxy resin, bisphenol F epoxy resin, or a combination thereof;
the diglycidyl ether comprises a diglycidyl ether of neopentyl glycol, a diglycidyl ether of 1,4-butanediol, or diglycidyl ether of resorcinol;
the triglycidyl ether comprises trimethylolpropane triglycidyl ether;
the tetraglycidyl ether comprises pentaerythritol tetraglycidyl ether;
the novolac epoxy resin comprises epoxy phenol novolac, epoxy cresol novolac, or a combination thereof, and wherein the novolac epoxy resin has an epoxy functionality of 3-6; or
a combination thereof.

6. The bio-based resin according to claim 1, wherein the bio-based component further comprises fatty acid derivatives, rosin acid derivatives, or a combination thereof.

7. The bio-based resin according to claim 6, wherein:
the fatty acid derivatives comprise dimer fatty acids, acrylic acid modified fatty acids, maleic anhydride modified fatty acids, or a combination thereof;
the rosin acid derivatives comprise hydrogenated rosins, disproportionated rosins, maleic anhydride modified rosins, fumaric acid modified rosins, or a combination thereof; or
a combination thereof.

8. The bio-based resin according to claim 1, wherein a molar ratio of the glycidyl ether component to the bio-based component is about 0.5:1 to about 1.5:1, about 0.9:1 to about 1.1:1, or about 1:2.

9. The bio-based resin according to claim 1, wherein:
the glycidyl ether component is bisphenol A epoxy resin, and the bio-based component is a distilled tall oil comprising up to about 50 wt % rosin acids, based on the total weight of the distilled tall oil;
the glycidyl ether component is a bisphenol A epoxy resin and a novolac epoxy resin, and the bio-based component is a distilled tall oil comprising up to about 50 wt % rosin acids, based on the total weight of the distilled tall oil;
the glycidyl ether component is triglycidyl ether and novolac epoxy resin, and the bio-based component is a distilled tall oil comprising up to about 50 wt % rosin acids, based on the total weight of distilled tall oil; or
the glycidyl ether component is trimethylolpropane triglycidyl ether, and bio-based component is a distilled tall oil comprising from about 50 wt % to about 70 wt % rosin acid, based on the total weight of the bio-based component.

10. A curable composition comprising:
bio-based resin obtained from a reaction mixture comprising a glycidyl ether component and a bio-based component comprising a fatty acid and a rosin acid, wherein the glycidyl ether component comprises at least two epoxide groups; and
an auxiliary epoxy resin.

11. The curable composition of claim 10, wherein a ratio of bio-based resin to auxiliary epoxy resin is about 10:90 to about 90:10, about 25:75 to about 75:25, or about 50:50.

12. The curable composition of claim 10, wherein
the glycidyl ether component is bisphenol A epoxy resin, and the bio-based component is a distilled tall oil comprising up to about 50 wt % rosin acids; or
the glycidyl ether component is a mixture of bisphenol A epoxy resin and a novolac epoxy resin, and the bio-based component is a distilled tall oil comprising up to about 50 wt % rosin acids; or
the glycidyl ether component is a mixture of triglycidyl ether and novolac epoxy resin, and the bio-based component is a distilled tall oil comprising up to about 50 wt % rosin acids, each based on the total weight of the bio-based component.

13. A polyurethane comprising repeating units derived from the bio-based resin of claim 1.

14. The polyurethane of claim 13, wherein the molar ratio of the glycidyl ether component to the bio-based component is about 1:2 in the reaction mixture for obtaining the bio-based resin.

15. The polyurethane of claim 13 comprising repeating units derived from a polyether polyol, a polyester polyol, a polyol derived from a natural oil, a polycaprolactone polyol, or a combination thereof.

16. The polyurethane of claim 13 comprising repeating units derived from a monomeric isocyanate, an oligomeric isocyanate, a polymeric isocyanate, or a combination thereof.

17. The polyurethane of claim 16, wherein:
the isocyanate comprises diphenylmethane diisocyanate; 3,3′-dimethyl-4,4′-biphenylene diisocyanate; a toluene diisocyanate; a polymeric diphenylmethane diisocyanate; a modified liquid 4,4′-diphenylmethane diisocyanate; hexamethylene-diisocyanate; 4,4′dicyclohexylmethane diisocyanate, isophorone diisocyanate, para-phenylene diisocyanate, meta-phenylene diisocyanate, tetramethylene diisocyanate; dodecane diisocyanate; octamethylene diisocyanate; decamethylene diisocyanate; cyclobutane-1,3-diisocyanate; 1,2-, 1,3- and 1,4-cyclohexane diisocyanate; 2,4- and 2,6-methylcyclohexane diisocyanate; 4,4′- and 2,4′-dicyclohexyldiisocyanate; 1,3,5-cyclohexane triisocyanate; a isocyanate-methylcyclohexane isocyanate; a isocyanatoethylcyclohexane isocyanate; a bis(isocyanatomethyl)-cyclohexane diisocyanate; 4,4′- and 2,4′-bis(isocyanatomethyl) dicyclohexane; isophorone diisocyanate; 2,4- and 2,6-hexahydrotoluenediisocyanate; 1,2-, 1,3- and 1,4-phenylene diisocyanate; triphenyl methane-4,4′,4″-triisocyanate; naphthylene-1,5-diisocyanate; 2,4′-, 4,4′- and 2,2-biphenyl diisocyanate; a polyphenyl polymethylene polyisocyanate, meta-tetramethylxylene diisocyanate, para-tetramethylxylene diisocyanate, or a combination thereof;
the fatty acid is derived from soybean oil, canola oil, tall oil, safflower oil, linseed oil, castor oil, corn oil, sunflower oil, olive oil, sesame oil, cottonseed oil, palm-based oil, rapeseed oil, tung oil, peanut oil, jatropha oil, or a combination thereof; or
a combination thereof.

18. The polyurethane of claim 15 obtained from a reaction mixture comprising
about 1-99 wt % bio-based resin; and
about 1-99 wt % of a polyol.

19. The polyurethane of claim 15 obtained from a reaction mixture comprising
about 50-99 wt % bio-based resin; and
about 1-50 wt % a polycaprolactone polyol.

20. The polyurethane of claim 17 obtained from a reaction mixture comprising
about 50-99 wt % bio-based resin; and
about 1-50 wt % castor oil.

21. The polyurethane of claim 15 obtained from a reaction mixture comprising
about 1-50 wt % bio-based resin;
about 1-20 wt % a polycaprolactone polyol; and
about 1-30 wt % castor oil.
